(19) United States
(12) Patent Application Publication
(10) Pub. No.: US 2026/0341294 A1
(43) Pub. Date: Oct. 29, 2026

(54) Fast and Multi-Lingual Speech Restoration Model

(71) Applicant: GDM Holding LLC, Mountain View, CA (US)

(72) Inventors: Yuma Koizumi, Tokyo (JP); Shigeki Karita, Tokyo (JP); Byungha Chun, Tokyo (JP); Haruko Ishikawa, Tokyo (JP); Michiel A. U. Bacchiani, Summit, NJ (US)

(73) Assignee: GDM Holding LLC, Mountain View, CA (US)

(21) Appl. No.: 19/565,126

(22) Filed: Mar. 12, 2026

Related U.S. Application Data
(60) Provisional application No. 63/793,557, filed on Apr. 23, 2025.

(51) Int. Cl. G10L 21/0208; G10L 13/027

(52) U.S. Cl. CPC G10L 21/0208; G10L 13/027; G10L 2021/02082

(57) ABSTRACT

A method includes receiving, as input to a speech restoration model, a sequence of acoustic frames representing degraded speech; generating, using at least one subsampling layer of an encoder of the speech restoration model, a subsampled representation based on the sequence of acoustic frames; and generating, using a stack of conformer blocks of the encoder of the speech restoration model, restored features based on the subsampled representation generated by the at least one subsampling layer. The stack of conformer blocks include one or more parallel adapters. The stack of conformer blocks are derived from a trained speech recognition model and adapted for speech restoration via training the one or more parallel adapters. The method also includes generating, using a vocoder of the speech restoration model, a restored sequence of acoustic frames that restores the degraded speech based on the restored features generated by the stack of conformer blocks.

### CROSS-REFERENCE TO RELATED APPLICATIONS

This U.S. Patent Application claims priority under 35 U.S.C. § 119(e) to U.S. Provisional Application 63/793,557, filed on Apr. 23, 2025. The disclosure of this prior application is considered part of the disclosure of this application and is hereby incorporated by reference in its entirety.

### TECHNICAL FIELD

This disclosure relates to fast and multi-lingual speech restoration models.

### BACKGROUND

Training large-scale speech generation models requires vast amounts of high-quality audio data across diverse languages. However, acquiring such datasets presents significant challenges. Existing speech data, especially large datasets collected from various real-world sources, often suffer from quality degradations such as noise and reverberation, rendering them suboptimal for training high-fidelity generative models.

Moreover, many speech restoration systems struggle to effectively process the sheer scale of data needed and often fail to handle the linguistic diversity, particularly for low-resource languages where high-quality studio recordings are scarce or unavailable.

Relying on additional information, for example, manual transcriptions or metadata for conditioning restoration models, is often impractical for large-scale datasets.

### SUMMARY

One aspect of the disclosure provides a computer-implemented method that when executed on data processing hardware causes the data processing hardware to perform operations that include receiving, as input to a speech restoration model, a sequence of acoustic frames representing degraded speech; generating, using at least one subsampling layer of an encoder of the speech restoration model, a subsampled representation based on the sequence of acoustic frames; and generating, using a stack of conformer blocks of the encoder of the speech restoration model, restored features based on the subsampled representation generated by the at least one subsampling layer. The stack of conformer blocks include one or more parallel adapters. The stack of conformer blocks are derived from a trained speech recognition model and adapted for speech restoration via training the one or more parallel adapters. The operations also include generating, using a vocoder of the speech restoration model, a restored sequence of acoustic frames that restores the degraded speech based on the restored features generated by the stack of conformer blocks.

Implementations of the disclosure may include one or more of the following optional features. In some implementations, the encoder is derived from a speech recognition model trained using self-supervised learning on a multilingual dataset without requiring transcriptions. The operations may also include: generating, using a first subsampling layer, a first subsampled representation based on the sequence of acoustic frames; and generating, using a second subsampling layer, a second subsampled representation based on the first subsampled representation generated by the first subsampling layer. Here, each of the first and second subsampling layers may include a convolutional layer, a layer norm module, and a Rectified Linear Unit (ReLU).

In some examples, the operations also include: generating, using a feedforward layer of the encoder, projected features based on the subsampled representation generated by the at least one subsampling layer; and generating, using a positional embedding layer of the encoder, position-encoded features based on the projected features generated by the feedforward layer. Each conformer block in the stack of conformer blocks may include a self-attention layer configured to model global dependencies, a convolutional layer configured to model local dependencies, and at least one layer norm module. Furthermore, within each conformer block, a respective parallel adapter may operate in parallel to at least one multilayer perceptron (MLP), while an output of the respective parallel adapter may be combined with an output of the at least one MLP.

In some implementations, the operations also include training the speech restoration model by obtaining a plurality of clean training utterances, and for each respective clean training utterance, generating a corresponding augmented training utterance. Training the speech restoration model further includes generating training pairs each comprising a corresponding clean training utterance and a corresponding augmented training utterance, and for each respective training pair: generating corresponding target restored features based on the corresponding clean training utterance; generating corresponding predicted restored features based on the corresponding augmented training utterance; and determining a respective encoder loss based on the corresponding target restored features and the corresponding predicted restored features. Finally, the speech restoration model is trained by training the encoder based on the respective encoder loss determined for each respective training pair. Training the encoder of the speech restoration model may include training the one or more parallel adapters and a layer norm module while all other components of the encoder remain frozen during training. In these implementations, training the speech restoration model may further include: generating, using the vocoder, a target restored sequence of acoustic frames based on the corresponding clean training utterance; determining a pre-training vocoder loss based on the target restored sequence of acoustic frames and the corresponding clean training utterance; pre-training the vocoder based on the pre-training vocoder loss; generating, using the vocoder, a predicted restored sequence of acoustic frames based on the corresponding augmented training utterance; determining a fine-tuning vocoder loss based on the predicted restored sequence of acoustic frames and the corresponding clean training utterance; and fine-tuning the vocoder on the fine-tuning vocoder loss.

Another aspect of the disclosure provides a speech restoration model that may execute on data processing hardware based on instructions stored on memory hardware. The speech restoration model includes at least one subsampling layer of an encoder configured to: receive, as input, a sequence of acoustic frames representing degraded speech; and generate a subsampled representation. The speech restoration model further includes a stack of conformer blocks of the encoder that include one or more parallel adapters. The stack of conformer blocks are derived from a trained speech recognition model and adapted for speech restoration via training the one or more parallel adapters. The stack of conformer blocks is configured to: receive, as input, the subsampled representation generated by the at least one subsampling layer; and generate restored features. The speech restoration model further includes a vocoder. The vocoder is configured to: receive, as input, the restored features generated by the stack of conformer blocks; and generate a restored sequence of acoustic frames that restores the degraded speech.

This aspect of the disclosure may include one or more of the following optional features. In some implementations, the encoder is derived from a speech recognition model trained using self-supervised learning on a multilingual dataset without requiring transcriptions. The at least one subsampling layer may include a first subsampling layer and a second subsampling layer. The first subsampling layer is configured to: receive, as input, the sequence of acoustic frames; and generate a first subsampled representation. The second subsampling layer is configured to: receive, as input, the first subsampled representation generated by the first subsampling layer; and generate a second subsampled representation. Here, each of the first and second subsampling layers comprises a convolutional layer, a layer norm module, and a Rectified Linear Unit (ReLU).

In some examples, the encoder further includes a feedforward layer and a positional embedding layer. The feedforward layer configured is configured to: receive, as input, the subsampled representation generated by the at least one subsampling layer; and generate projected features. The positional embedding layer is configured to: receive, as input, the projected features generated by the feedforward layer; and generate position-encoded features.

Each conformer block in the stack of conformer blocks may include a self-attention layer configured to model global dependencies, a convolutional layer configured to model local dependencies, and at least one layer norm module. Furthermore, within each conformer block, a respective parallel adapter may operate in parallel to at least one multilayer perceptron (MLP), while an output of the respective parallel adapter may be combined with an output of the at least one MLP.

In some implementations, the operations also include training the speech restoration model by obtaining a plurality of clean training utterances, and for each respective clean training utterance, generating a corresponding augmented training utterance. Training the speech restoration model further includes generating training pairs each comprising a corresponding clean training utterance and a corresponding augmented training utterance, and for each respective training pair: generating corresponding target restored features based on the corresponding clean training utterance; generating corresponding predicted restored features based on the corresponding augmented training utterance; and determining a respective encoder loss based on the corresponding target restored features and the corresponding predicted restored features. Finally, the speech restoration model is trained by training the encoder based on the respective encoder loss determined for each respective training pair. Training the encoder of the speech restoration model may include training the one or more parallel adapters and a layer norm module while all other components of the encoder remain frozen during training. In these implementations, training the speech restoration model may further include: generating, using the vocoder, a target restored sequence of acoustic frames based on the corresponding clean training utterance; determining a pre-training vocoder loss based on the target restored sequence of acoustic frames and the corresponding clean training utterance; pre-training the vocoder based on the pre-training vocoder loss; generating, using the vocoder, a predicted restored sequence of acoustic frames based on the corresponding augmented training utterance; determining a fine-tuning vocoder loss based on the predicted restored sequence of acoustic frames and the corresponding clean training utterance; and fine-tuning the vocoder on the fine-tuning vocoder loss.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a schematic view of an example system executing a speech restoration model.

FIG. 2 is a schematic view of an example subsampling layer of the speech restoration model.

FIG. 3 is a schematic view of an example conformer block in a stack of conformer blocks of the speech restoration model.

FIG. 4 is a schematic view of an example training process for training the speech restoration model.

FIG. 5 is a schematic view of an example training process for training a speech generation model using the trained speech restoration model.

FIG. 6 is a schematic view of an example computing device that may be used to implement the systems and methods described herein.

FIG. 7 is a flowchart of an example arrangement of operations for a method of using a speech restoration model to restores degraded speech.

Like reference symbols in the various drawings indicate like elements.

### DETAILED DESCRIPTION

Recent advancements in deep learning have led to the development of increasingly sophisticated speech generative speech models capable of producing highly realistic and natural-sounding speech for application like text-to-speech (TTS) synthesis and voice conversion. The performance and quality achieved by these large-scale models are dependent on the availability of vast amounts of training data, often requiring millions of hours of speech recordings. While large speech datasets exist, much of this data, particularly that sourced from diverse and uncontrolled acoustic environments, suffers from various forms of degradation, including background noise, reverberation, clipping, and codec compression artifacts. Training generative speech models directly on such degraded speech may impair the output quality and effectiveness of the generate speech models.

A significant challenge lies in the need for these large datasets to encompass a wide range of languages to enable truly multilingual speech generation capabilities.

However, collecting high-quality, studio-grade recordings across hundreds or thousands of languages is often economically or logistically prohibitive. Consequently, large multilingual datasets frequently include speech with inconsistent and often poor acoustic quality. Existing speech restoration techniques, which aim to clean degraded speech signals, often struggle to generalize effectively across this linguistic diversity, particular of languages unseen during training.

Moreover, many speech restoration models rely on auxiliary information, such as accurate transcriptions of the speech content or speaker identity information, to condition the speech restoration models and achieve high-fidelity results. While effective, obtaining such conditioning information for large, multi-lingual datasets spanning millions of hours is impractical due to the prohibitive cost and effort required for manual annotation or the unreliability of automatic methods across diverse languages and acoustic conditions. This necessitates restoration approaches that operate effectively without relying on such external conditioning information.

To that end, implementations herein are directed towards a speech restoration model and training process thereof. The speech restoration model includes at least one subsampling layer (e.g., a first subsampling layer and a second subsampling layer) of an encoder that is configured to generate a subsampled representation based on a sequence of acoustic frames representing degraded speech. The speech restoration model includes a stack of conformer blocks of the encoder. The stack of conformer blocks includes one or more parallel adapters. Moreover, the stack of conformer blocks is derived from a trained speech recognition model and is adapted for speech restoration via training of the one or more parallel adapters. The stack of conformer blocks is configured to generate restored features based on the subsampled representation generated by the at least one subsampling layer. The speech restoration model includes a vocoder configured to generate a restored sequence of acoustic frames that restores the degraded speech based on the restored features generated by the stack of conformer blocks.

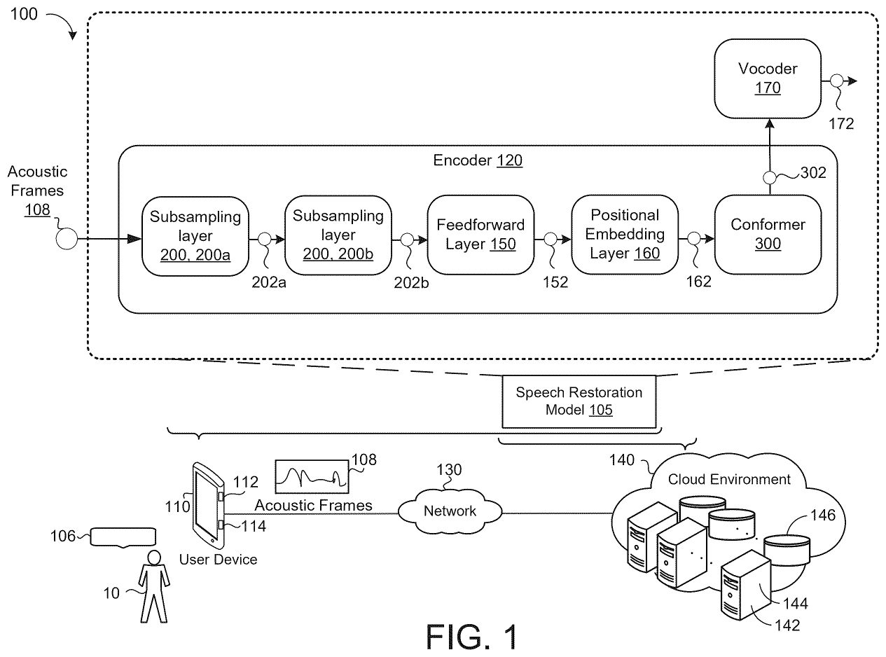

Referring to FIG. 1, in some implementations, a system 100 includes a user device 110 capturing speech utterances 106 spoken by one or more users 10 and communicating with a remote system 140 via a network 130. The remote system 140 may be a distributed system (e.g., cloud computing environment) having scalable/elastic resources 142. The resources 142 include computing resources 144 (e.g., data processing hardware) and/or storage resources 146 (e.g., memory hardware). The user device 110 and/or the remote system 140 execute a speech restoration model 105.

The user device 110 includes data processing hardware 112 and memory hardware 114. The user device 110 may include an audio capture device (e.g., microphone) for capturing and converting the speech utterances 106 (also referred to as simply “utterances 106”) from users 10 into the sequence of acoustic frames 108 (e.g., input audio data). In some implementations, the user device 110 is configured to execute a portion of the speech restoration model 105 locally (e.g., using the data processing hardware 112) while a remaining portion of the speech restoration model 105 executes on the remote system 140 (e.g., using data processing hardware 144). Alternatively, the speech restoration model 105 may execute entirely on the user device 110 or remote system 140. The user device 110 may be any computing device capable of communicating with the remote system 140 through the network 130. The user device 110 includes, but is not limited to, desktop computing devices and mobile computing devices, such as laptops, tablets, smart phones, smart speakers/displays, smart appliances, internet-of-things (IoT) devices, and wearable computing devices (e.g., headsets and/or watches).

The speech restoration model 105 includes an encoder 120 and a vocoder 170. The encoder 120 is integrated into the speech restoration model 105 from a pre-existing speech recognition model. The speech recognition model may have been pre-trained using self-supervised learning methods on a large, multilingual dataset without requiring manual transcriptions. The pre-training strategy allows the encoder 120 to learn general representations of speech characteristics across diverse languages and acoustic conditions, making the encoder robust even when explicitly conditioning features (e.g., transcriptions or speaker IDs) are unavailable. The integration involves leveraging the feature the feature extraction capabilities learned during the pre-training phase for the distinct task of speech restoration.

The encoder 120 is configured to extract robust acoustic features from the sequence of acoustic frames 108, often represented as mel-frequency filter banks (e.g., 128-dimensional features derived from 16 kHz input audio). The encoder 120 aims to preserve essential speech information even in the presence of noise or other forms of degradation. The encoder 120 includes at least one subsampling layer 200 (e.g., a first subsampling layer 200, 200a and a second subsampling layer 200b), a feedforward layer 150, a positional embedding layer 160, and a stack of conformer blocks 300. The first subsampling layer 200a may include a 128-channel convolutional layer (e.g., conv2d).

The first subsampling layer 200a is configured to receive, as input, the sequence of acoustic frames 108 and generate a first subsampled representation 202, 202a, which has a reduced sequence length and increased feature dimensionality per output step. The second subsampling layer 200b may include a 32-channel convolutional layer (e.g., conv2d). The second subsampling layer 200b is configured to receive, as input, the first subsampled representation 202a and generate a second subsampled representation 202, 202b, further reducing the sequence length.

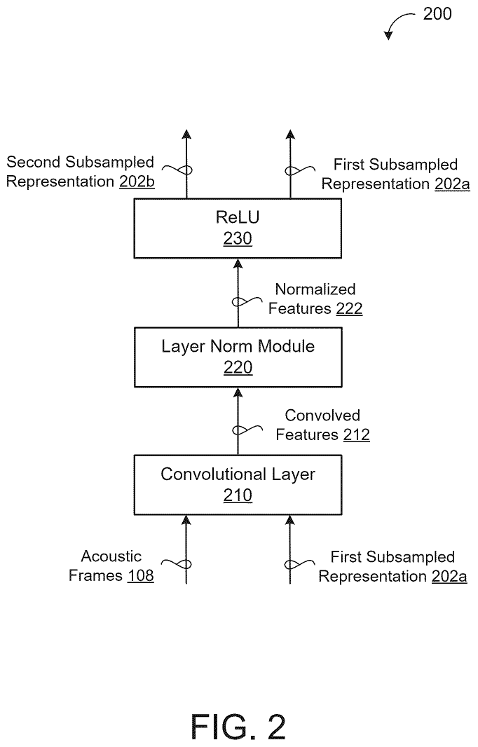

FIG. 2 illustrates an example subsampling layer 200 that may include a convolutional layer 210, a layer norm module 220, and a Rectified Linear Unit (ReLU) 230. The convolutional layer 210 may employ a convolutional kernel of size [3, 3] with a stride of [2, 2]. The kernel size determines the local receptive field for feature extraction, while the stride dictates that the kernel moves two steps in both the time and frequency (or feature) dimensions, thereby achieving the downsampling of the input representation while extracting local feature patterns. The convolutional layer 210 receives the sequence of acoustic frames 108 or the first subsampled representation 202a and generates convolved features 212. The layer norm module 220 generates normalized features 222 based on the convolved features 212. The ReLU 230 introduces non-linearity into the subsampling layer 200 and generates the first subsampled representation 202a or the second subsampled representation 202b based on the normalized features 222. For instance, the convolution layer 210 of the first subsampling layer 200a of FIG. 1 may receive the acoustic frames 108 and the ReLU 230 may generate the first subsampled representation 202a, while the convolution layer 210 of the second subsampling layer 200b of FIG. 1 may receive the first subsampled representation 202a output by the ReLU 230 of the first subsampling layer 200a and the ReLU 230 may generate the second subsampled representation 202b.

Referring back to FIG. 1, the feedforward layer 150 may include a high-dimensional (e.g., a 1536-dimensional) feedforward network (FFN). The feedforward layer 150 projects the second subsampled representation 202b into a higher-dimensional space (e.g., 1536 dimensions, matching the operating dimension of the subsequent stack of conformer blocks 300). The projection allows the speech restoration model 105 to represent and capture more complex relationships within the sequence of acoustic frames 108, and generates projected features 152. The positional embedding layer 160 injects information about the relative or absolution position of the sequence of frames 108 into the projected features 152. This positional information is important because the subsequent stack of conformer blocks 300, particularly the self-attention mechanisms, may not inherently process sequential order. The positional embedding layer 160 generates position-encoded features 162, which may include both acoustic information and the sequence position information and are then fed into the stack of conformer blocks 300.

The stack of confirmer blocks 300 operates in a high-dimensional space, for example, a 1536-dimensional space. The stack of conformer blocks 300 process the position-encoded features 162 sequentially, meaning the output of one conformer block 300 becomes the input to the next conformer block 300 in the stack of conformer blocks 300. In some examples, the stack of conformer blocks 300 may include a plurality of conformer blocks 300, for example, 13 conformer blocks 300. The stack of conformer blocks 300 generates restored features 302 as output from the last conformer block 300 in the stack of conformer blocks 300 based on the position-encoded features 162 after passing through all the conformer blocks 300 in the stack of conformer blocks 300. Each conformer block 300 effectively combines convolution, for capturing local acoustic patterns, and self-attention, for modeling long-range dependencies within the sequence of acoustic frames 108, providing a powerful mechanism for sequence modeling.

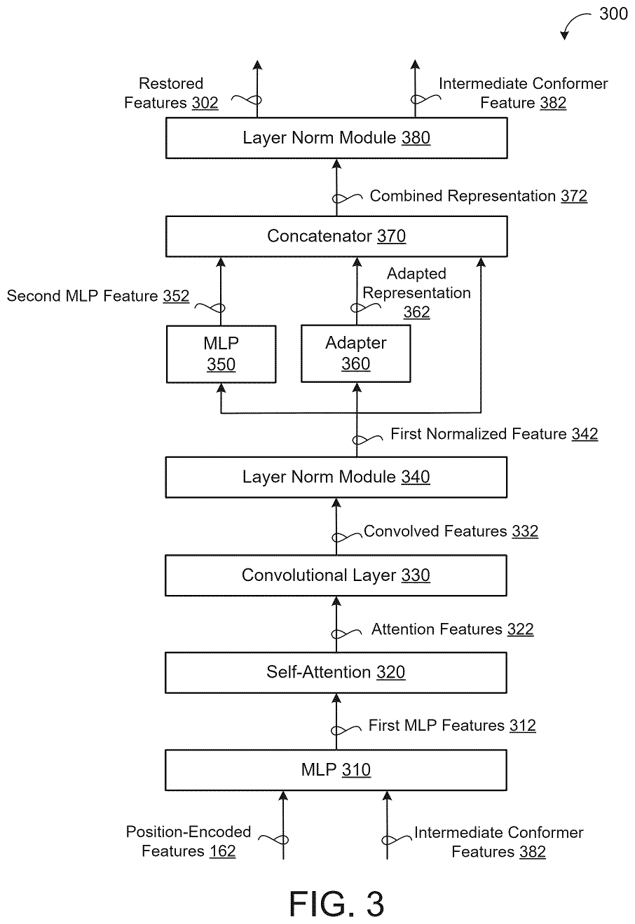

FIG. 3 illustrates an example single conformer block 300 from the stack of conformer blocks 300. The conformer block 300 includes a first multilayer perceptron (MLP) 310, a self-attention layer 320, a convolutional layer 330, a first layer norm module 340, a second MLP 350, a parallel adapter 360, an adder 370, and a second layer norm module 380. The first MLP 310 receives either intermediate conformer features 382 a prior conformer block 300 in the stack of conformer blocks 300 or the position-encoded features 162 (e.g., for the first conformer block 300 in the stack of conformer blocks 300) and generates first MLP features 312 through a non-linear transformation. The self-attention layer 320 generates attention features 322 based on the first MLP features 312 to capture global contextual information. Self-attention allows each position in the sequence to attend to all other positions, determining weighted sums based on feature similarity to generate the attention features 322. In some examples, the self-attention layer 320 generates the attention features 322 further based on the intermediate conformer features 382 or the position-encoded features 162 via a skip connection (e.g., residual connection) that bypasses the first MLP 310.

The convolutional layer 330 generates convolved features 332 based on the attention features 322 to model local correlations. The convolutional layer 330 applies local filters to capture local correlations and temporal patterns, complementing the global perspective of the self-attention layer 320. In some instances, the convolutional layer 330 generates the convolved features 332 further based on the first MLP features 312 via a skip connection that bypasses the self-attention layer 320. The first layer norm module 340 generates first normalized features 342 based on the convolved features 332. In some examples, the first layer norm module 340 normalizes the output of the convolutional layer 330 to stabilize activations before the next transformation, generating the first normalized features 342 based on the attention features 322 via a skip connection. The second MLP 350 generates second MLP features 352 352 based on the first normalized features 342.

In parallel to the main processing path involving the second MLP 350, the parallel adapter 360 generates an adapted representation 362 based on the first normalized features 342. The parallel adapter 360 may include a lightweight feedforward network configured to fine-tune the encoder 120 (FIG. 1) for the restoration task efficiently, adding task-specific adjustments. By inserting the parallel adapters 360, only the parameters within the parallel adapters 360 (and, in some examples, the layer norm modules) need to be trained or updated for the new speech restoration task, leaving the large pre-trained backbone (e.g., conformer blocks 300) largely unchanged.

The adder 370 combines the outputs from the parallel paths. For example, the adder 370 concatenates, or adds, the first normalized features 342, the second MLP features 352, and the adapted representation 362, to generate a combined representation 372. The second layer norm module 380 generates an intermediate conformer features 382 for the next conformer block 300 in the stack of conformer blocks 300 or restored features 302 (for the lack conformer block 300 in the stack of conformer blocks 300) based on the combined representation 372. The parallel adapter 360 architecture significantly enhances parameter efficiency, allowing the conformer blocks 300 to adapt to the speech restoration task using significantly fewer trainable parameters compared to fine-tuning the entire conformer block 300, enhancing both training and inference efficiency.

Referring back to FIG. 1, the vocoder 170 synthesizes the final audio output. That is, the vocoder 170 generates a restored sequence of acoustic frames 172 based on the restored features 302 received from the encoder 120. In some implementations, the vocoder 170 includes a neural vocoder such as a WaveFit vocoder, or other types including WaveNet, WaveRNN, HiFi-GAN, or similar generative models capable of producing high-quality audio waveforms. The vocoder 170 is configured to convert the restored features 302, which represent cleaned acoustic information derived from potentially noisy input, back into a high-fidelity audio waveform (e.g., 24 kHz restored waveform).

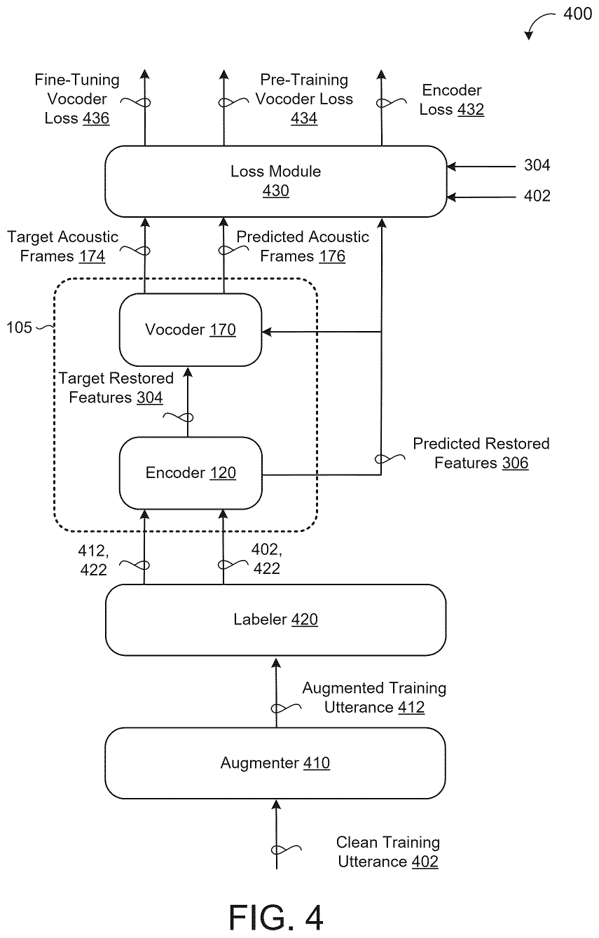

Referring now to FIG. 4, in some implementations, a training process 400 is employed to train the speech restoration model 105 to effectively remove various forms of degradation from speech input signals. Notably, the training process 400 uses a self-supervised training process. The training process 400 includes an augmenter, a labeler 420, and a loss module 430. The augmenter 410 receives a plurality of clean training utterance 402 that represent high-quality, undegraded audio data, serving as the ground-truth label. For each respective clean training utterance 402, the augmenter 410 generates one or more corresponding augmented training utterances 412. Here, the augmenter 410 artificially degrades (i.e., augments) each respective clean training utterance 402 by applying at least one of additive noise, reverberation, speech coding artifacts, clipping, or random equalization to the respective clean training utterance 402. As such, the augmentation of the cleaning training utterances 402 simulates the type of real-world degradations the speech enhancement model 105 is expected to encounter, creating realistic training examples. The labeler 420 receives both clean training utterances 412 and the corresponding augmented training utterances 412 and generates training pairs 422. That is, the labeler 420 pairs each augmented training utterance 412 with the corresponding clean training utterance 402. Thus, each training pair 422 includes a respective degraded input sample (e.g., augmented training utterance 412) and the corresponding desired clean output reference (e.g., clean training utterance 402), forming the basis for self-supervised learning.

During an encoder training phase of the training process 400, the encoder 120 receives the clean training utterance 402 and generates target restored features 304 based on the clean training utterance 402. The target restored features 304 represent the ideal, degradation-free feature representation that the encoder 120 should aim to output.

Moreover, the encoder 120 receives the corresponding augmented training utterance 412 from the same training pair 422 and generates predicted restored features 306 based on the augmented training utterance 412. The predicted restored features 306 represent the actual output of the encoder 120 when processing the degraded input. The encoder 120 generates the target restored features 304 and the predicted restored features 306 in a similar manner as generating the restored features 302 as described with reference to FIGS. 1-3.

The loss module 430 determines an encoder loss 432 based on a comparison between the target restored features 304 and the predicted restored features 306. The encoder loss 432 quantifies the discrepancy between the desired output (e.g., target restored features 304) and the actual output (e.g., predicted restored features 306). In some examples, the loss module 430 determines the encoder loss 432 using a distance metric such as L1 or L2 distance. The training process 400 trains the encoder 120 by adjusting trainable parameters of the encoder 120 to minimize the encoder loss 432. In particular, leveraging the parameter-efficient training strategy described above, the training process 400 trains only the parallel adapters 360 and/or the second layer norm module 380 within each conformer block 300 based on the encoder loss 432, while all other components of the encoder 120 (e.g., pre-trained conformer backbone, subsampling layers 200, etc.) remain frozen during the training process 400. This allows the speech restoration model 105 to adapt the powerful, pre-learned generate speech representations of the frozen backbone specifically to the task of speech restoration with minimal computational overhead.

Moreover, the training process 400 trains the vocoder 170. In some examples, the training process 400 may train the vocoder in stages, namely, a pre-training stage and a fine-tuning stage. The vocoder 170 generates a target restored sequence of acoustic frames 174 based on the target restored features 304 which were derived from the clean training utterance 402. The loss module 430 determines a pre-training vocoder loss 434 based on comparing the target restored sequence of acoustic frames 174 (e.g., synthesized audio) and the clean training utterance 402 (e.g., the ground-truth audio waveform). The training process 400 pre-trains the vocoder 170 based on the pre-training vocoder loss 434 determined for each training pair 422. After pre-training the vocoder 170, the fine-tuning stage adapts the vocoder 170 to the specific characteristics of features produced by the trained encoder 120. In this stage, the vocoder 170 generates a predicted restored sequence of acoustic frames 176 based on the predicted restored features 306 which were generated by the encoder 120 from the augmented training utterance 412. The loss module 430 determines a fine-tuning vocoder loss 436 based on comparing the predicted restored sequence of acoustic frames 176 (e.g., audio synthesized from the output of the encoder 120 for degraded input) and the clean training utterance 402 (e.g., the ground-truth audio waveform). The training process 400 fine-tunes the vocoder 170 based on the fine-tuning vocoder loss 436. This two-stage process ensures the vocoder 170 is capable of high-fidelity synthesis (e.g., learned during pre-training) and is subsequently optimized to work effectively with the output of the encoder 120 (e.g., learned during fine-tuning).

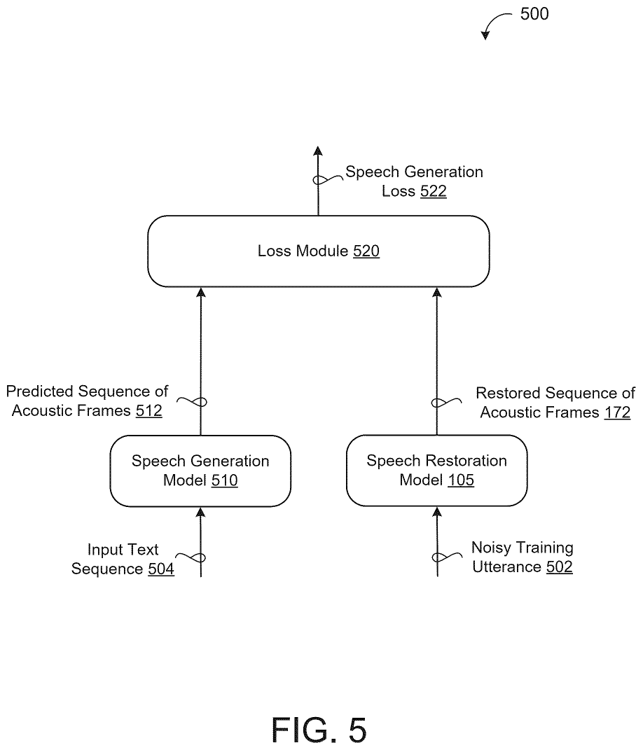

FIG. 5 illustrates an example training process 500 configured to train a downstream speech generation model 510, such as text-to-speech (TTS) synthesis model or a voice conversion (VC) model, leveraging the output of the previously trained speech restoration model 105. Notably, the training process 500 employs a self-supervised approach by utilizing readily available, potentially degraded speech data instead of requiring expensively curated clean datasets. The overall goal of the training process 400 is to enable the training of high-quality speech generation models even when the primary source of training audio is noisy or acoustically inconsistent. The training process 500 begins by obtaining a plurality of noisy training utterances 502. The noisy training utterances 502 represent the large-scale, multilingual, and acoustically diverse speech data, which may suffer from various forms of degradation but are often more readily available than studio-quality recordings.

For each noisy training utterance 502, the trained speech restoration model 105 processes the noisy training utterance 502 and generates a corresponding restored sequence of acoustic frames 172 (as described in FIGS. 1-4). The restored sequence of acoustic frames 172 serves as a high-quality, pseudo-clean target signal for training the speech generation model 510. The speech generation model 510, depending on its specific task (e.g., TTS or VC), takes appropriate input conditioning data. For example, in a TTS scenario, the speech generation model 510 generates a predicted sequence of acoustic frames 512 based on a corresponding input text sequence 504 (representing the transcript of the speech content) associated with the original noisy utterance 502. In a voice conversion scenario, the input might include features derived from the noisy utterance 502 along with target speaker information. Notably, the speech generation model 510 learns to generate its output (e.g., predicted sequence of acoustic frames 512) to match the corresponding restored sequence of acoustic frames 172 produced by the speech restoration model 105.

A loss module 520 determines a speech generation loss 522 based on comparing the predicted sequence of acoustic frames 512 (e.g., output by the speech generation model 510) and the corresponding restored sequence of acoustic frames 172 (e.g., generated by the speech restoration model 105). This comparison quantifies the difference between the predicted sequence of acoustic frames and the corresponding restored sequence of acoustic frames 172. The training process 500 trains the speech generation model 510 by adjusting parameters (e.g., neural network weights) of the speech generation model 510 to minimize the speech generation loss value 522 determined for each training sample derived from a noisy training utterance 502. This self-supervised loop, using the restored speech as the target, effectively teaches the speech generation model 510 to produce clean, high-fidelity speech corresponding to the input condition (e.g., input text sequence 504), implicitly learning from the vast amount of information present in the large, noisy training utterances 502 after the noisy training utterances are cleaned by the speech restoration model 105. Thereafter, the trained speech generation model 510 may be deployed for inference, where the speech generation model 510 may, for instance, obtain new input text sequences 504 and generate the predicted sequence of acoustic frames 512 as high-quality synthesized speech output.

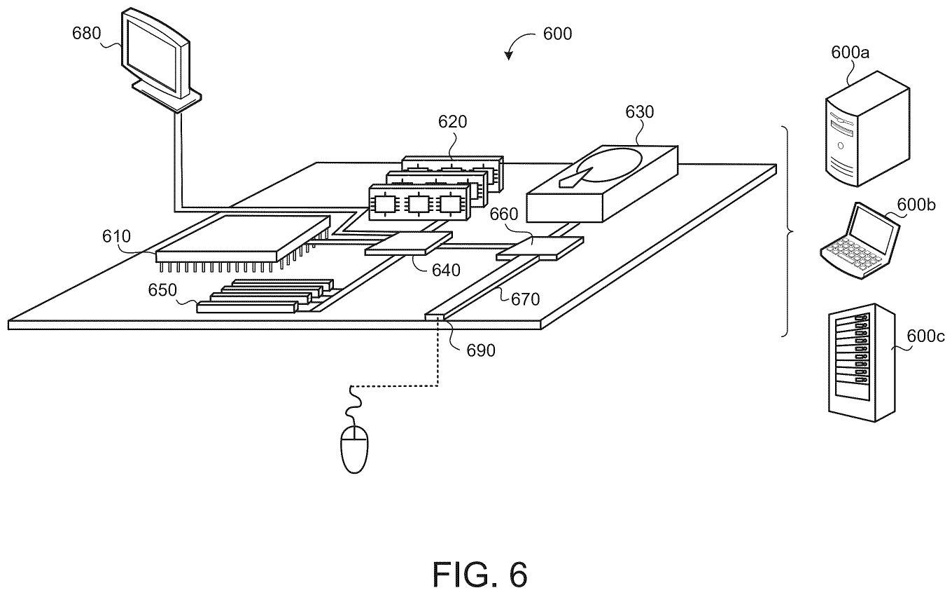

FIG. 6 is a schematic view of an example computing device 600 that may be used to implement the systems and methods described in this document. The computing device 600 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 600 includes a processor 610, memory 620, a storage device 630, a high-speed interface/controller 640 connecting to the memory 620 and high-speed expansion ports 650, and a low speed interface/controller 660 connecting to a low speed bus 670 and a storage device 630. Each of the components 610, 620, 630, 640, 650, and 660, are interconnected using various busses, and may be mounted on a common motherboard or in other manners as appropriate. The processor 610 can process instructions for execution within the computing device 600, including instructions stored in the memory 620 or on the storage device 630 to display graphical information for a graphical user interface (GUI) on an external input/output device, such as display 680 coupled to high speed interface 640. In other implementations, multiple processors and/or multiple buses may be used, as appropriate, along with multiple memories and types of memory. Also, multiple computing devices 600 may be connected, with each device providing portions of the necessary operations (e.g., as a server bank, a group of blade servers, or a multi-processor system).

The memory 620 stores information non-transitorily within the computing device 600. The memory 620 may be a computer-readable medium, a volatile memory unit(s), or non-volatile memory unit(s). The non-transitory memory 620 may be physical devices used to store programs (e.g., sequences of instructions) or data (e.g., program state information) on a temporary or permanent basis for use by the computing device 600. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs).

Examples of volatile memory include, but are not limited to, random access memory (RAM), dynamic random access memory (DRAM), static random access memory (SRAM), phase change memory (PCM) as well as disks or tapes.

The storage device 630 is capable of providing mass storage for the computing device 600. In some implementations, the storage device 630 is a computer-readable medium. In various different implementations, the storage device 630 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer-or machine-readable medium, such as the memory 620, the storage device 630, or memory on processor 610.

The high speed controller 640 manages bandwidth-intensive operations for the computing device 600, while the low speed controller 660 manages lower bandwidth-intensive operations. Such allocation of duties is exemplary only. In some implementations, the high-speed controller 640 is coupled to the memory 620, the display 680 (e.g., through a graphics processor or accelerator), and to the high-speed expansion ports 650, which may accept various expansion cards (not shown). In some implementations, the low-speed controller 660 is coupled to the storage device 630 and a low-speed expansion port 690. The low-speed expansion port 690, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 600 may be implemented in a number of different forms, as shown in the figure. For example, it may be implemented as a standard server 600a or multiple times in a group of such servers 600a, as a laptop computer 600b, or as part of a rack server system 600c.

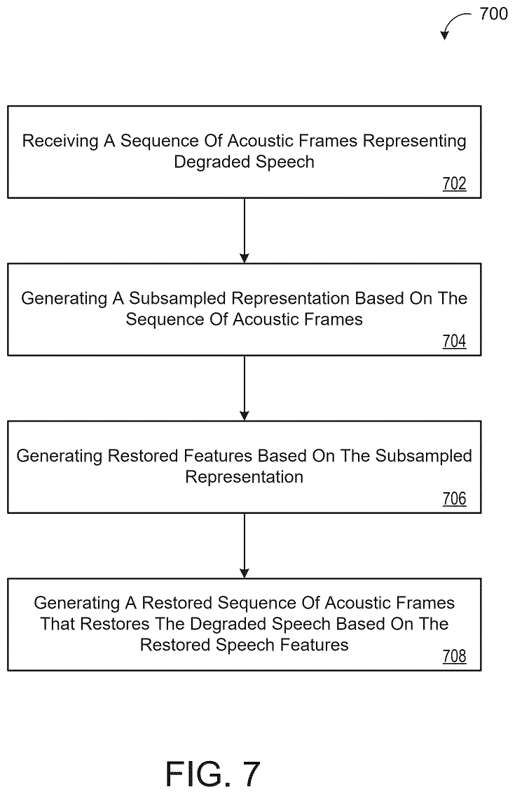

FIG. 7 is a flowchart of an example arrangement of operations for a computer-implemented method 700 for generating restored speech using a speech restoration model 105. The method 700 may execute on data processing hardware 610 (FIG. 6) using instructions stored on memory hardware 620 (FIG. 6). The data processing hardware 610 and the memory hardware 620 may reside on the user device 110 and/or the remote system 140 each corresponding to a computing device 600 (FIG. 6).

At operation 702, the method 700 includes receiving, as input to the speech restoration model 105, a sequence of acoustic frames 108 representing degraded speech. At operation 704, the method 700 includes generating, using at least one subsampling layer 200 of an encoder 120 of the speech restoration model 105, a subsampled representation 202a, 202b based on the sequence of acoustic frames 108.

At operation 706, the method 700 includes generating, using a stack of conformer blocks 300 of the encoder 120 of the speech restoration model 105, restored features 302 based on the subsampled representation 202a, 202b generated by the at least one subsampling layer 200. Here, the stack of conformer blocks 300 includes one or more parallel adapters 360. Furthermore, the stack of conformer blocks 300 is derived from a trained speech recognition model and adapted for speech restoration via training the one or more parallel adapters 360, At operation 708, the method 700 also includes generating, using a vocoder 170 of the speech restoration model 150, a restored sequence of acoustic frames 172 that restores the degraded speech based on the restored features 302 generated by the stack of conformer blocks 300.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer.

Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

What is claimed is:

1. A system comprising:
data processing hardware; and
memory hardware in communication with the data processing hardware and storing instructions that when executed on the data processing hardware causes the data processing hardware to execute a speech restoration model, the speech recognition model comprising:
at least one subsampling layer of an encoder configured to:
receive, as input, a sequence of acoustic frames representing degraded speech; and
generate a subsampled representation;
a stack of conformer blocks of the encoder comprising one or more parallel adapters, the stack of conformer blocks derived from a trained speech recognition model and adapted for speech restoration via training the one or more parallel adapters, the stack of conformer blocks configured to:
receive, as input, the subsampled representation generated by the at least one subsampling layer; and
generate restored features; and
a vocoder configured to:
receive, as input, the restored features generated by the stack of conformer blocks; and
generate a restored sequence of acoustic frames that restores the degraded speech.

2. The system of claim 1, wherein the encoder is derived from a speech recognition model trained using self-supervised learning on a multilingual dataset without requiring transcriptions.

3. The system of claim 1, wherein the at least one subsampling layer comprises:
a first subsampling layer configured to:
receive, as input, the sequence of acoustic frames; and
generate a first subsampled representation; and
a second subsampling layer configured to:
receive, as input, the first subsampled representation generated by the first subsampling layer; and
generate a second subsampled representation.

4. The system of claim 3, wherein each of the first and second subsampling layers comprises a convolutional layer, a layer norm module, and a Rectified Linear Unit (ReLU).

5. The system of claim 1, wherein the encoder further comprises:
a feedforward layer configured to:
receive, as input, the subsampled representation generated by the at least one subsampling layer; and
generate projected features; and
a positional embedding layer configured to:
receive, as input, the projected features generated by the feedforward layer; and
generate position-encoded features.

6. The system of claim 1, wherein each conformer block in the stack of conformer blocks further comprises:
a self-attention layer configured to model global dependencies;
a convolutional layer configured to model local dependencies; and
at least one layer norm module.

7. The system of claim 6, wherein:
within each conformer block, a respective parallel adapter operates in parallel to at least one multilayer perceptron (MLP), and an output of the respective parallel adapter is combined with an output of the at least one MLP.

8. The system of claim 1, wherein the speech restoration model is trained by:
obtaining a plurality of clean training utterances;
for each respective clean training utterance, generating a corresponding augmented training utterance, generating training pairs each comprising a corresponding clean training utterance and a corresponding augmented training utterance;
for each respective training pair:
generating corresponding target restored features based on the corresponding clean training utterance;
generating corresponding predicted restored features based on the corresponding augmented training utterance; and
determining a respective encoder loss based on the corresponding target restored features and the corresponding predicted restored features; and
training the encoder of the speech restoration model based on the respective encoder loss determined for each respective training pair.

9. The system of claim 8, wherein training the encoder of the speech restoration model comprises training the one or more parallel adapters and a layer norm module while all other components of the encoder remain frozen during training.

10. The system of claim 8, wherein the speech restoration model is further trained by:
generating, using the vocoder, a target restored sequence of acoustic frames based on the corresponding clean training utterance;
determining a pre-training vocoder loss based on the target restored sequence of acoustic frames and the corresponding clean training utterance;
pre-training the vocoder based on the pre-training vocoder loss;
generating, using the vocoder, a predicted restored sequence of acoustic frames based on the corresponding augmented training utterance;
determining a fine-tuning vocoder loss based on the predicted restored sequence of acoustic frames and the corresponding clean training utterance; and
fine-tuning the vocoder on the fine-tuning vocoder loss.

11. A computer-implemented method executed on data processing hardware that causes the data processing hardware to perform operations comprising:
receiving, as input to a speech restoration model, a sequence of acoustic frames representing degraded speech;
generating, using at least one subsampling layer of an encoder of the speech restoration model, a subsampled representation based on the sequence of acoustic frames;
generating, using a stack of conformer blocks of the encoder of the speech restoration model, restored features based on the subsampled representation generated by the at least one subsampling layer, the stack of conformer blocks comprising one or more parallel adapters, the stack of conformer blocks derived from a trained speech recognition model and adapted for speech restoration via training the one or more parallel adapters; and
generating, using a vocoder of the speech restoration model, a restored sequence of acoustic frames that restores the degraded speech based on the restored features generated by the stack of conformer blocks.

12. The method of claim 11, wherein the encoder is derived from a speech recognition model trained using self-supervised learning on a multilingual dataset without requiring transcriptions.

13. The method of claim 11, wherein the operations further comprise:
generating, using a first subsampling layer, a first subsampled representation based on the sequence of acoustic frames; and
generating, using a second subsampling layer, a second subsampled representation based on the first subsampled representation generated by the first subsampling layer.

14. The method of claim 13, wherein each of the first and second subsampling layers comprises a convolutional layer, a layer norm module, and a Rectified Linear Unit (ReLU).

15. The method of claim 11, wherein the operations further comprise:
generating, using a feedforward layer of the encoder, projected features based on the subsampled representation generated by the at least one subsampling layer; and
generating, using a positional embedding layer of the encoder, position-encoded features based on the projected features generated by the feedforward layer.

16. The method of claim 11, wherein each conformer block in the stack of conformer blocks further comprises:
a self-attention layer configured to model global dependencies;
a convolutional layer configured to model local dependencies; and
at least one layer norm module.

17. The method of claim 16, wherein:
within each conformer block, a respective parallel adapter operates in parallel to at least one multilayer perceptron (MLP), and
an output of the respective parallel adapter is combined with an output of the at least one MLP.

18. The method of claim 11, wherein the operations further comprise training the speech restoration model by:
obtaining a plurality of clean training utterances;
for each respective clean training utterance, generating a corresponding augmented training utterance;
generating training pairs each comprising a corresponding clean training utterance and a corresponding augmented training utterance;
for each respective training pair:
generating corresponding target restored features based on the corresponding clean training utterance;
generating corresponding predicted restored features based on the corresponding augmented training utterance; and
determining a respective encoder loss based on the corresponding target restored features and the corresponding predicted restored features; and
training the encoder of the speech restoration model based on the respective encoder loss determined for each respective training pair.

19. The method of claim 18, wherein training the encoder of the speech restoration model comprises training the one or more parallel adapters and a layer norm module while all other components of the encoder remain frozen during training.

20. The method of claim 18, wherein training the speech restoration model further comprises:
generating, using the vocoder, a target restored sequence of acoustic frames based on the corresponding clean training utterance;
determining a pre-training vocoder loss based on the target restored sequence of acoustic frames and the corresponding clean training utterance;
pre-training the vocoder based on the pre-training vocoder loss;
generating, using the vocoder, a predicted restored sequence of acoustic frames based on the corresponding augmented training utterance;
determining a fine-tuning vocoder loss based on the predicted restored sequence of acoustic frames and the corresponding clean training utterance; and
fine-tuning the vocoder on the fine-tuning vocoder loss.
